(19) United States
(12) Patent Application Publication
(10) Pub. No.: US 2020/0243864 A1
(43) Pub. Date: Jul. 30, 2020

(54) Inhibiting Sulfur Shuttle Behaviors In High-Energy Lithium-Sulfur Batteries

(71) Applicant: BOARD OF TRUSTEES OF THE UNIVERSITY OF ARKANSAS, Little Rock, AR (US)

(72) Inventor: Xiangbo Meng, Fayetteville, AR (US)

(73) Assignee: BOARD OF TRUSTEES OF THE UNIVERSITY OF ARKANSAS, Little Rock, AR (US)

(21) Appl. No.: 16/847,619

(22) Filed: Apr. 13, 2020

Related U.S. Application Data
(63) Continuation of application No. 15/921,096, filed on Mar. 14, 2018.
(60) Provisional application No. 62/471,161, filed on Mar. 14, 2017.

(51) Int. Cl. H01M 4/62; H01M 10/052; B01J 20/28; B01J 20/22; B01J 20/08; H01M 4/136; H01M 4/36; H01M 4/38; H01M 10/42

(52) U.S. Cl. CPC H01M 4/628; H01M 10/052; B01J 20/28007; B01J 20/22; H01M 2004/028; H01M 4/136; H01M 4/366; H01M 4/38; H01M 10/4235; B01J 20/08

(57) ABSTRACT

A method of inhibiting sulfur shuttle behaviors in lithium-sulfur batteries comprising the steps of combining S-adsorbent nanoparticles deposited by atomic layer deposition (ALD) or/and molecular layer deposition (MLD) and flexible polymeric films deposited by MLD

### RELATED APPLICATIONS

This application claims the benefit of U.S. Provisional Application No. 62/471,161 filed Mar. 14, 2017, and herein incorporated by reference.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

With the quick depletion of fossil fuels (i.e., coal, petroleum, and natural gas), renewable clean energies have been pursued as the alternatives, such as solar radiation and wind power being the future primary energy supplies. However, the intermittent operational nature of both the solar and wind power requires energy storage devices for implementation.

Batteries are to date one of the most successful energy storage devices, storing electrical energy in the form of chemical energy. A typical battery system consists of three main components, i.e., anodes, cathodes, and liquid electrolytes. Of various commercial battery systems, lithium-ion batteries (LIBs) are now a favored technology in terms of energy density and dominates various consumer electronic applications. A LIB cell conventionally consists of a carbon anode (negative electrode, e.g., graphite), a lithium metal oxide cathode (positive electrode, e.g., LiCoO₂), an electronically insulating separator, and an ionically conductive electrolyte to transfer lithium ions between the two electrodes. Electrolytes can be a liquid, a gel or solid polymer, or an inorganic solid. In most cases, LIBs use liquid electrolytes containing a lithium salt such as LiPF₆, LiBF₄, LiBC₄O₈, and Li[PF₃(C₂F₅)₃], which dissolves in a mixture of organic alkyl carbonate solvents like ethylene, dimethyl, diethyl, and ethyl methyl carbonate. An external connection between the two electrodes induces a spontaneous flow of electrons from an anode to a cathode, due to their different chemical potentials dictated by the materials' chemistry. LIBs rely on the shuttling of lithium-ions back and forth between the two electrodes during charge-discharge cycles. The materials' chemistry governs both cell voltage and capacity. LIBs were first commercialized in 1991 by Sony Corporation. Currently, LIBs can provide a voltage of the order of 4 V and specific energy ranging from 100 to 150 Wh/kg. There are three main application domains for LIBs: portable electronics, transport, and stationary storage. The first is the most developed and largest in terms of the number of produced units while the other two are expected to be boosted with new battery technologies. At present, the construction of large stationary batteries as centralized facilities is quite expensive. A most notable scaled-up application is for hybrid electrical vehicles (HEVs), plug-in hybrid electric vehicles (PHEVs), and pure electrical vehicles (EVs). Unfortunately, conventional LIBs (e.g., C/LiCoO₂ batteries) suffer from a series of problems for transportation use due to the cost, safety, cell energy density (voltagexcapacity), rate of charge-discharge, and service life, whose roots lie in anodes, cathodes, electrolytes, or the interrelations between them. More specifically, LIBs must be able to operate at realistic temperatures (a range from −46 to +66° C.) with 5000 charge-discharge cycles and a 15-year calendar life. However, these are still challenging for current LIB technologies.

To power pure electric vehicles for 300 miles per charge, a battery system is required to be able to provide an energy density of 300 Wh/kg. To this end, state-of-the-art LIBs are still insufficient. Associated with research efforts in developing next-generation LIBs, new battery systems beyond LIBs are under development as well, such as lithium-sulfur (Li—S) batteries and lithium-oxygen (Li—O₂) batteries. In comparison to LIBs, Li—S batteries utilize lithium metal as the anode and sulfur as the cathode and are superior to LIBs. With the dramatically reduced cost, Li—S batteries can offer a theoretical energy density of −2600 Wh/kg, 10 times higher than LIBs. Thus, Li—S batteries are a promising energy storage device for powering electric vehicles in terms of their high gravimetric energy density.

However, the commercialization of the Li—S batteries for transportation is being hindered by a series of technical issues. Among the issues, the low electrical and ionic conductivity of S and Li₂S (5×10⁻³° S/cm at 25° C.) make the transport of both electrons and lithium ions very sluggish, and this challenges high rate capabilities. The S cathode, on the other hand, experiences the unavoidable production of various intermediate polysulfides (Li₂Sₙ, 3≤n≤8) during charge and discharge and the highly soluble nature of the polysulfides permits the free migration between the cathode and anode (i.e., the so-called S shuttle phenomenon). The S shuttle behaviors are prone to result in low Coulombic efficiency and continuous capacity fading of Li—S batteries. To counteract the extremely low conductivity of S/Li₂S, conductive additives such as carbon-based materials are often used to synthesize S related nanocomposites. In addressing the polysulfide solubility problem, various immobilizers and physically confinement structures have been developed. However, in most cases, these immobilizers and confining structures add significantly to the weight and volume of the cathodes, thereby reducing the Li—S energy density. Surface coatings of inorganic and polymeric materials also have been investigated, but the conventional coating methods (e.g., solution-based methods) are not good at controlling the thickness and uniformity of the coating materials at the optimal level and thus often are not favorable for achieving high loading S cathodes.

Despite efforts, a commercially feasible technology for Li—S batteries is still needed. In recent years, atomic layer deposition (ALD) has been tested as a new thrust to tackle the challenges of Li—S batteries. Using ALD, metal oxides (e.g., Al₂O₃, ZnO, TiO₂, MgO) have been deposited on S cathodes to perform as physical barriers or adsorbents of polysulfides. The ALD coatings exhibited effective enhancement on the performance of Li—S batteries, but they were not able to eliminate the S shuttle behaviors. The insulating and inflexible nature of the ALD coatings also had exerted some adverse effect on the S cathodes. Later than ALD coatings, MLD coatings were also investigated in the past few years for improving Li—S batteries. An MLD film has been used as a physical barrier to help confine polysulfides from shuttling between the cathode and anode of Li—S batteries.

### SUMMARY OF THE INVENTION

Lithium-sulfur (Li—S) batteries are one of the most promising energy storage devices in terms of their high gravimetric energy density and low cost (2600 Wh/kg in comparison to 100-220 Wh/kg of Li-ion batteries). One of the main hurdles for commercializing Li—S batteries is the production of soluble polysulfides and their shuttling behaviors.

The embodiments of the present invention are aimed at addressing the S shuttle phenomenon by synergistically combining S-adsorbent nanoparticles by atomic layer deposition (ALD) or/and molecular layer deposition (MLD) and a polymeric nanofilm by MLD. The resultant Li—S cells can achieve a specific cell energy density of >1500 Wh/kg, at least five times over the state-of-the-art lithium-ion batteries.

In one embodiment, the present invention provides a novel and effective strategy in eliminating or reducing the sulfur shuttling phenomenon in Li—S batteries by combining atomic layer deposition (ALD) and molecular layer deposition (MLD). Embodiments of the present invention provide Li—S batteries with the energy densities several times higher than the state-of-the-art lithium-ion batteries at a more effective cost.

In yet other embodiments, the present invention uses ALD and MLD techniques to reduce or eliminate sulfur shuttling in Li—S batteries. For this embodiment, ALD is used for depositing inorganic adsorbents in nanoparticles, and MLD is employed to grow a close flexible film outside the S cathode materials. The two functional materials (i.e., the S-adsorbent nanoparticles and the flexible polymeric nanofilm) can work synergistically for thoroughly inhibiting the S shuttle behaviors in Li—S batteries. Consequently, the resultant Li—S batteries also are reliable in cyclability and Coulombic efficiency.

In yet other embodiments, the use of ALD and MLD enable accurately optimizing the addition of the S-adsorbents and flexible polymeric films to the minimum amount for the highest performance of Li—S batteries. In other words, the invention enables S cathodes with much higher S loadings and thereby a much higher energy density of Li—S batteries.

In yet other embodiments, the present invention provides methods of creating Li—S batteries having higher ionic and electrical conductivities of S cathodes and enables high rate capabilities of Li—S batteries. For these embodiments, besides anchoring soluble polysulfides, the ALD/MLD-deposited S-adsorbents can serve as mediators of the S active materials for improved electrical and ionic conductivity. In addition to behaving like a flexible reservoir of polysulfides, on the other hand, the MLD-grown flexible polymeric films act as a flexible network to boost the electrical conductivity and mechanical integrity of the S cathode.

In yet other embodiments, the present invention provides Li—S batteries that are high-energy, low-cost, and have longer useful life.

In yet other embodiments, the present invention provides Li—S batteries that may be used in a wide range of applications, covering portable electronics such as cell phones and laptops; transportation (e.g., electric vehicles); smart grids; and autonomous devices (e.g., pacemakers).

In yet other embodiments, the present invention provides Li—S batteries which are made by a combination of ALD and MLD to inhibit S shuttling behaviors and improving S conductivities with minimum additives.

In yet other embodiments, the present invention reduces or eliminates S shuttling behaviors in Li—S batteries, rendering the batteries reliable in Coulombic efficiency and long-term cyclability.

In still further embodiments, besides inhibiting S loss, the dual protection methods of the present invention greatly improve the conductivities of the S cathodes and therefore enable high rate capabilities of the Li—S batteries.

In still further embodiments, the present invention, by using both ALD and MLD, enables a dramatic reduction in the addition of non-active materials thereby boosting the electroactive S mass ratio resulting in higher energy densities of the resultant Li—S batteries.

In still further embodiments, the present invention provides a dual protection strategy for effectively eliminating sulfur shuttling in Li—S batteries. ALD or/and MLD are used for depositing adsorbents in nanoparticles and MLD or/and ALD is employed to grow a close flexible film outside the S cathode materials. The two functional materials (i.e., the S-adsorbent nanoparticles and the flexible polymeric/inorganic nanofilms) can work synergically for thoroughly inhibiting the S shuttle behaviors in Li—S batteries. Consequently, the resultant Li—S batteries also are reliable in cyclability and Coulombic efficiency. For example, S-adsorbents can be deposited on conductive supports (such as graphene and carbon nanotubes) first in nanoparticles by ALD or/and MLD. Then, the resultant nanoparticle-decorated supports are mixed with S (or Li₂S), a binder (e.g., polyvinylidene fluoride), and a conductive additive (e.g., carbon black) in a certain ratio in a solvent (e.g. N-methyl-2-pyrrolidone) to make a slurry. The slurry is further casted onto a current collector (e.g., Carbon, Cu, or Al foil) for S (Li₂S) electrodes. The dried S (or Li₂S) electrodes are further coated with a polymeric film by MLD. Therefore, the resultant S (or Li₂S) electrode is protected by both ALD-deposited nanoparticles and MLD-deposited polymeric films, enabling to minimize/eliminate S shuttling in Li—S batteries.

In still further embodiments, the present invention uses ALD and MLD to enable accurately optimizing the addition of the S-adsorbents and flexible films to the minimum amount for the highest performance of Li—S batteries. This enables S cathodes with much higher S loadings and thereby a much higher energy density of Li—S batteries.

In still further embodiments, the present invention is capable of higher ionic and electrical conductivities of S cathodes and enables high rate capabilities of Li—S batteries. Besides anchoring soluble polysulfides, the ALD/MLD-deposited S-adsorbents can serve as mediators of the S active materials for improved electrical and ionic conductivity. In addition to behaving like a flexible reservoir of polysulfides, on the other hand, the MLD/ALD-grown flexible films act as a network to boost the electrical conductivity of the S cathode to current collectors (e.g., Al, Cu, and other metal foils).

In still further embodiments, the present invention combines both ALD and MLD for resolving technical issues in Li—S batteries.

In still further embodiments, the present invention inhibits S shuttling behaviors and improving S conductivities with the minimum additives.

In still further embodiments, the present invention thoroughly eliminates S shuttling behaviors in Li—S batteries.

In still further embodiments, the present invention besides inhibiting S loss, the dual protection deployed greatly improves the conductivities of the S cathodes and therefore enables high rate capabilities of the Li—S batteries.

In still further embodiments, the present invention uses of ALD and MLD to enable a dramatic reduction in the addition of non-active materials, and to boost the electroactive S mass ratio, and ultimately renders a much higher energy density of the resultant Li—S batteries.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIGS. 1A and 1B. Illustrations of ALD and MLD process: (a) a typical ALD process enabling inorganic material growth at the atomic level and (b) a typical MLD process enabling organic material growth at the molecular level.

FIG. 2. Illustration of discharge and charge process of Li—S batteries, in which there are soluble polysulfides (Li₂S₈, Li₂S₆, Li₂S₄, and Li₂S₃) produced. The shuttle of the polysulfides cause low Coulombic efficiency and capacity fading of Li—S batteries. In addition, the oxidative S and reductive Li₂S are insoluble but highly insulating electrically and ionically.

FIGS. 3A and 3B. Illustration of the invention for tackling S shuttle and low conductivity of S and Li₂S. (a) S cathode suffers from S shuttle and S loss; (b) ALD/MLD-deposited S-adsorbents and MLD/ALD-coated flexible polymeric/inorganic films work synergically to inhibit S shuttle and improve both the electrical and ionic conductivity of S/Li₂S cathodes.

FIGS. 4A and 4B. Electrochemical performance of Electrode #1, Electrode #2, Electrode #3, and Electrode #4: (a) specific capacity versus discharge-charge cycles and (b) Coulombic efficiency.

FIGS. 5A and 5B. SEM images of Electrode #4: (a) high magnification and (b) low magnification.

FIGS. 6A, 6B and 6C. SEM images of (a) NG, (b) NG deposited with ZnO of 5 ALD cycles, and (c) NG deposited with Al₂O₃ of 5 ALD cycles.

FIGS. 7A and 7B. Observation on adsorption abilities of different powders to Li₂S₆: (a) initial samples and (b) samples after 3 hours. From left to right, the samples are (i) Li₂S₆ solution, (ii) Li₂S₆ solution with a piece of separator, (iii) Li₂S₆ solution with 3-mg NG powder, (iv) Li₂S₆ solution with 3-mg NG powder coated with 1-cycle ALD ZnO, (v) Li₂S₆ solution with 3-mg NG powder coated with 5-cycle ALD ZnO, (vi) Li₂S₆ solution with 3-mg NG powder coated with 10-cycle ALD ZnO, and (vii) Li₂S₆ solution with 3-mg NG powder coated with 20-cycle ALD ZnO.

FIGS. 8A and 8B. (a) The first discharge-charge profiles of the four electrodes and (b) the electrochemical regions of S electrodes.

FIG. 9. Effects of MLD coatings on the electrochemical performance: the discharge capacity of Electrode #3 (without coating) and Electrode #5 (with 10-cycle MLD coating of ZnGLP).

FIGS. 10A and 10B. QCM measurements of the MLD linear growth of alucone AlGLP at 50° C.: (a) 20 cycles and (b) 3 consecutive cycles.

FIGS. 11A and 11B. QCM measurements of the MLD linear growth of alucone AlGL at (a) 50° C. and (b) 75° C.

FIGS. 12A and 12B. QCM measurements of the MLD linear growth of zincone ZnGLP at 50° C.: (a) 20 cycles and (b) 3 consecutive cycles.

FIGS. 13A and 13B. QCM measurements of the MLD linear growth of zincone ZnGL at (a) 50° C. and (b) 75° C.

FIGS. 14A, 14B and 14C. SEM images of (a) bare NG, (b) 20-cycle AlGLP coated NG at 50° C., and (c) 10-cycle ZnGL coated NG at 50° C.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

Lithium-sulfur (Li—S) batteries are superior to lithium-ion batteries (LIBs), in terms of cost and energy density. Li—S batteries can provide an energy density of −2600 Wh/kg, 10 times higher than LIBs. However, Li—S batteries have (i) low conductivity of S cathodes (5×10⁻³° S/cm at 25° C.) and (ii) S shuttle effects during charge-discharge cycles. The two issues make Li—S batteries unreliable during extended cycling life, exhibiting continuous capacity fading and low Coulombic efficiency. In addressing the two issues, the embodiments of the present invention provide novel technical approaches using both atomic layer deposition (ALD) and molecular layer deposition (MLD).

Atomic layer deposition (ALD) enables the layer-by-layer growth of inorganic materials accurately controlled at the atomic level. ALD operates in a cycle-by-cycle repeatable mode and each cycle renders a growth of a single layer of inorganic materials. A typical growth per cycle is around 0.2 nm. Also, ALD features its low growth temperature of <400° C. typically and unrivaled growth uniformity over large-scale substrates. ALD's growth relies on surface reactions and thus enables material growth on any substrates of different shapes with reactive surface sites. Therefore, the ALD growth is particularly conformal as well.

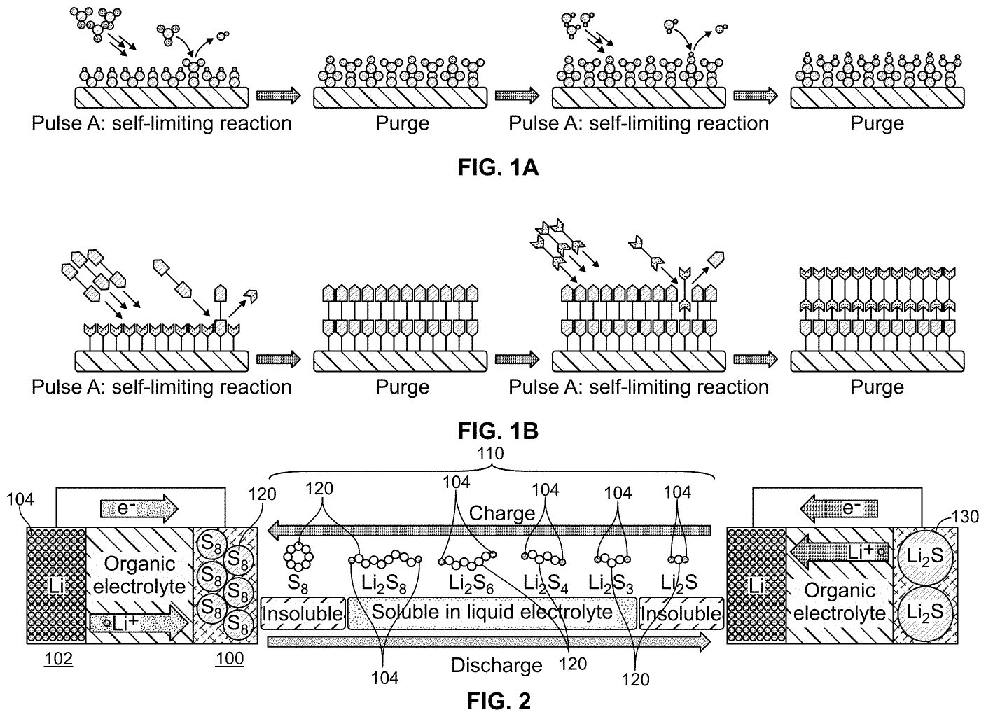

Analogous to ALD, molecular layer deposition (MLD) grows organic materials at the molecular level of 0.5 nm per cycle. MLD also has the characteristics of the layer-by-layer growth, low growth temperature, and uniform and conformal deposition. The two techniques only differ in the resultant materials, i.e., inorganic materials from ALD while organic materials from MLD (see FIG. 1).

As shown in FIG. 2, in Li—S batteries, the S cathode (100) material (120) will be reduced into a series of polysulfides (110; Li₂Sₙ, 3≤n≤8), including Li₂S₈, Li₂S₆, Li₂S₄, and Li₂S₃, and ultimately into Li₂S₂ and Li₂S. Polysulfides (110) are highly soluble in liquid electrolytes as shown in FIG. 2.

The dissolved polysulfides then can transfer to the anode (102) side of lithium metal (104), where they react with lithium metal (104) to produce low-order polysulfides and then migrate back to S cathode (100) side to form high-order polysulfides, and so on. This S shuttling behaviors cause low Coulobmic efficiency and continuous capacity fading. This notorious shuttle phenomenon adversely hinders the commercialization of Li—S batteries. Also, both the oxidative S (120) and reductive Li₂S (130) are highly electrically and ionically insulating. This makes S cathode (100) very sluggish in discharge and charge process.

In certain embodiments, the present invention provides a novel solution to address the S shuttle behaviors and improve the conductivities of the S/Li₂S cathode materials, which combines both the ALD and MLD.

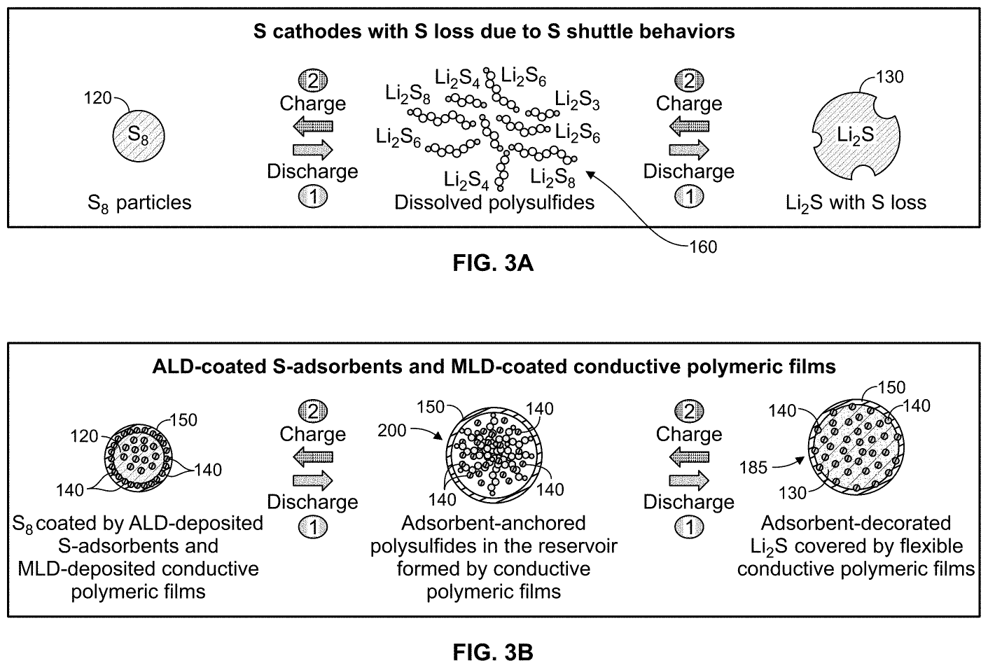

As shown in FIGS. 3A and 3B, in certain embodiments the present invention provides for the growth of inorganic nanoparticles (140) and organically polymeric films (150). For certain embodiments, ALD or/and MLD are utilized for depositing nanoparticles (140). The ALD- or/and MLD-deposited inorganic/organic nanoparticles (140) act as S-adsorbents. As shown in FIG. 3B, the present invention includes, among other things, Li—S power sources that include S₈ particles (120) coated by deposited inorganic nanoparticles (140) and both are, in turn, coated by polymeric film (150). Also included are adsorbent-anchored polysulfides in a resservior (200) formed by conductive film (150). The polysulfides are anchored by nanoparticles (140). Further included are cathode materials (185), which may be S/Li₂S, that are decorated or coated with nanoparticles (140). The decorated or coated particles are further covered by conductive film (150).

The S-adsorbents in nanoparticles by ALD/MLD act as: (i) anchors of soluble polysulfides (160), which chemically prevent S species from shuttling between the S cathode and the lithium metal anode, and (ii) mediators of the S active materials for improved electrical and ionic conductivity. The nanoscale S-adsorbents (140) can be inorganics, organics, or inorganic-organic hybrids. On the other hand, ALD or/and MLD are employed to grow a flexible film (150) outside the S/Li₂S cathode materials (185). The polymeric/inorganic films (150) by MLD/ALD also are bifunctional as: (i) a flexible reservoir of polysulfides (200), which blocks the direct contact between S active materials with the liquid electrolyte, physically retains excess polysulfides from escaping from the S cathode, and accumulate 80% volume change of S active materials; and (ii) a network to further boost the electrical contact of the S cathode materials to current collectors (e.g., Al, Cu, and other metal foils). The outer coating films (150) can be inorganics, organics, or inorganic-organic hybrids. The two functional materials (i.e., the S-adsorbent nanoparticles and the outer polymeric/inorganic nanofilms) can work synergically to thoroughly inhibit the S shuttle behaviors in Li—S batteries. At the same time, they will also work together to improve both the electrical and ionic conductivity of the S cathode. In particular, ALD and MLD enable accurately optimizing the addition of the S-adsorbents (140) and outer polymeric/inorganic films (150) to the minimum amount for the highest performance of Li—S batteries. As a result, S loss may be reduced, inhibited or eliminated while realizing the cell-specific energy density of >1500 Wh/kg (5-10 times over the state-of-the-art lithium-ion batteries). With the improved electrical and ionic conductivity of the S/Li₂S cathode, the resultant Li—S batteries also enable high rate capabilities for exceptional discharge and charge performance.

There were four types of sulfur (i.e., S) cathodes investigated: Electrode #1: 60 wt. % S, 30 wt. % Super P carbon black, 10 wt. % polyvinylidene fluoride (PVDF). Electrode #2: 60 wt. % S, 10 wt. % Super P, 20 wt. % nitrogen-doped graphene (i.e., NG), 10 wt. % PVDF. Electrode #3: 60 wt. % S, 10 wt. % Super P, 20 wt. % NG coated with ALD-deposited 0.5 nm (i.e., 5 cycles) ZnO nanoparticles, 10 wt. % PVDF. Electrode #4: 60 wt. % S, 10 wt. % Super P, 20 wt. % NG coated with ALD-deposited 0.5 nm (i.e., 5 cycles) Al₂O₃ nanoparticles, 10 wt. % PVDF. Electrode #5: Electrode #3 coated with MLD-deposited films.

All the mixtures for Electrodes of #1, #2, #3, and #4 were ground for 1 hour in the presence of the N-methyl-2-pyrrolidone (NMP) solvent using a ball milling machine and thereby a homogeneous slurry was received with S nanoparticles. The resultant slurry was cast onto Al foils and expanded into laminates using a doctor blade with tunable thickness ranging from 50 to 200 microns. Electrode #5 was the Electrode #3 coated with MLD-deposited polymeric films of AlGL, AlGLP, ZnGL, or ZnGLP (GL=Glycerol, and GLP=Glycerol Propoxylate).

The dried laminates were punched into 7/16-inch circular electrodes and subsequently assembled into CR2032 LIB coin cells in an Ar-filled glove box with H₂O and O₂ levels below 1 ppm. Li metal was used as the counter/reference electrode, a Celgard 2325 membrane was used as the separator, and 1 M lithium bis(trifluoromethanesulfonyl)imide (LITFSI) in 1,3-dioxolane (DOL) and 1,2-dimethoxyethane (DME) (DOL:DME=1:1 by volume) was used as the electrolyte. The discharge-charge testing was performed on a Neware battery cycler using a voltage window of 1.5-3.0 V for the resultant S cathodes. All of the electrochemical testing was performed at room temperature.

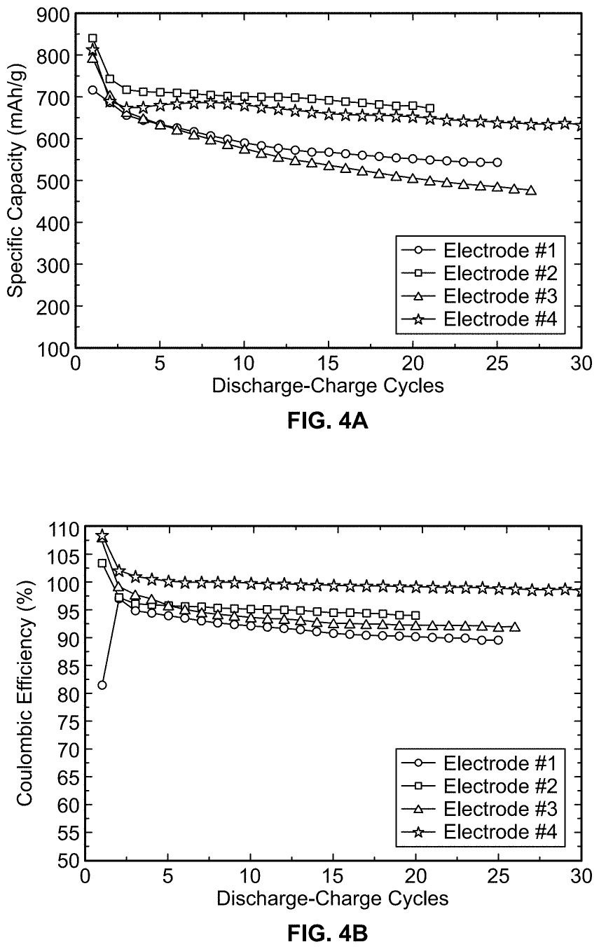

As illustrated in FIG. 4(a), the Electrodes (i.e., #1, #2, #3, and #4) varied in their discharge capacities with discharge-charge cycles at the current density of 500 mA/g. Electrode #2 and #4 showed similar capacities, having much better sustainability of their capacities over Electrode #1 and #3. The Electrodes enabled a capacity-fading rate of 0.96% per cycle for #1, 0.9% per cycle for #2, 1.47% per cycle for #3, and 0.7% per cycle for #4, respectively. Thus, ALD-deposited Al₂O₃ nanoparticles enabled the Electrode #4 the best sustainability and a sustainable capacity of 633 mAh/g after 30 cycles. FIG. 4(b) illustrates the Coulombic efficiency (CE) of the four electrodes. Obviously, Electrode #4 has the highest CE of >98.6% after 30 cycles while the CEs are 90%, 94%, and 92% for Electrode #1, #2, and #3 after 20 cycles, respectively. It is evident that ALD-deposited Al₂O₃ nanoparticles exhibited excellent inhibiting effects on S shuttling.

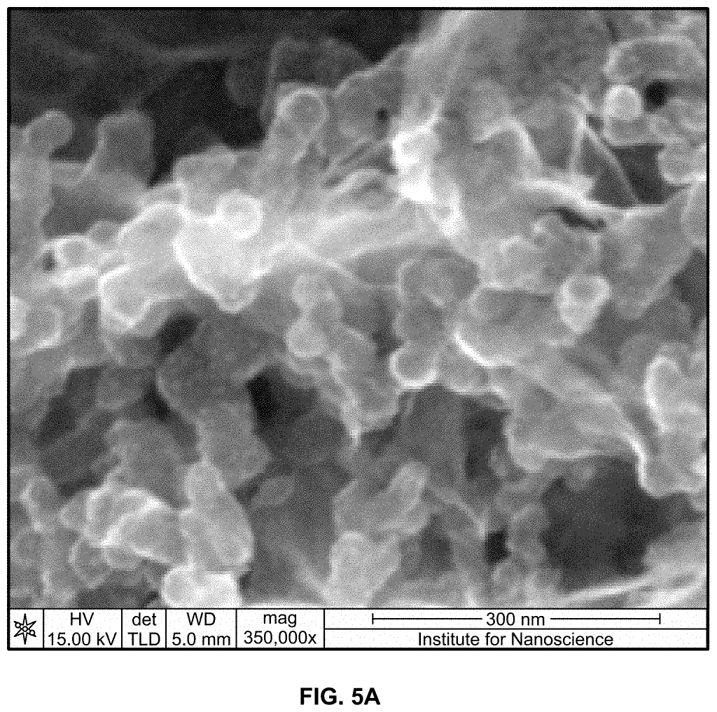

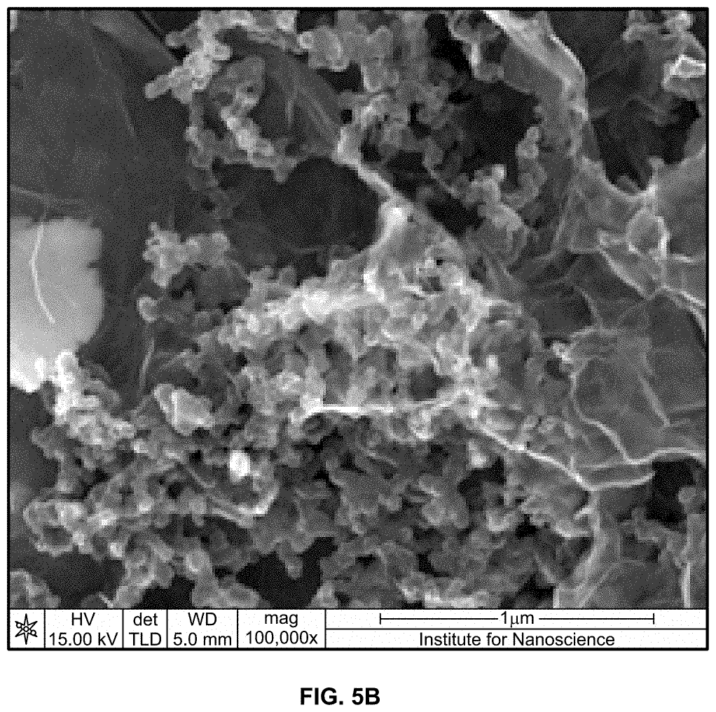

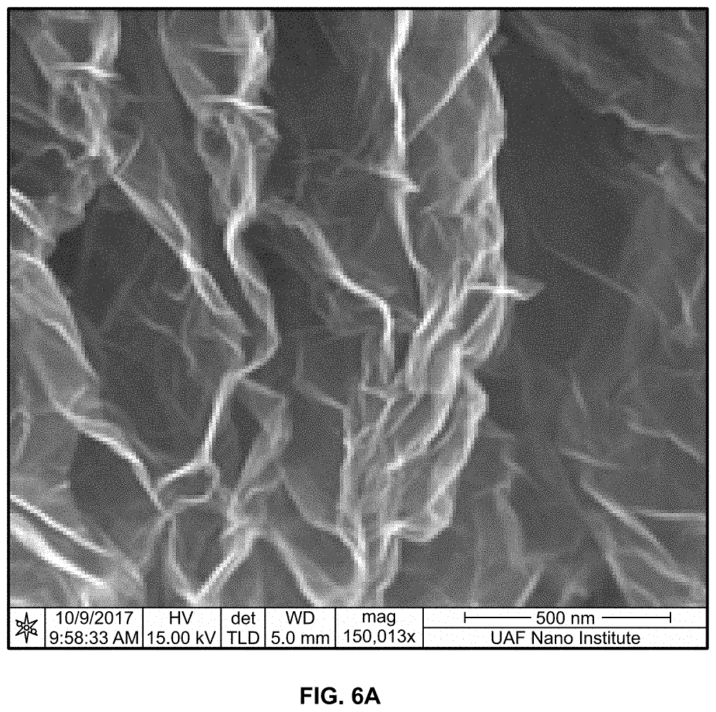

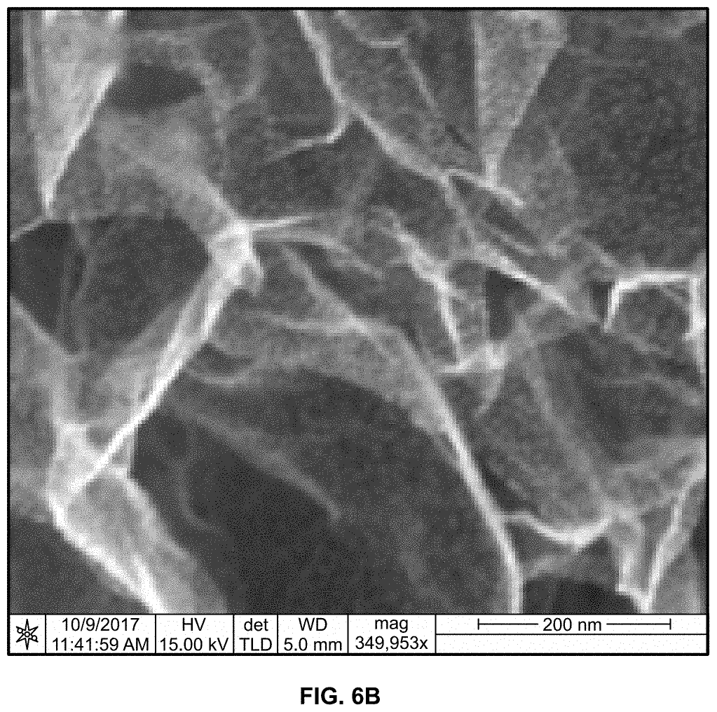

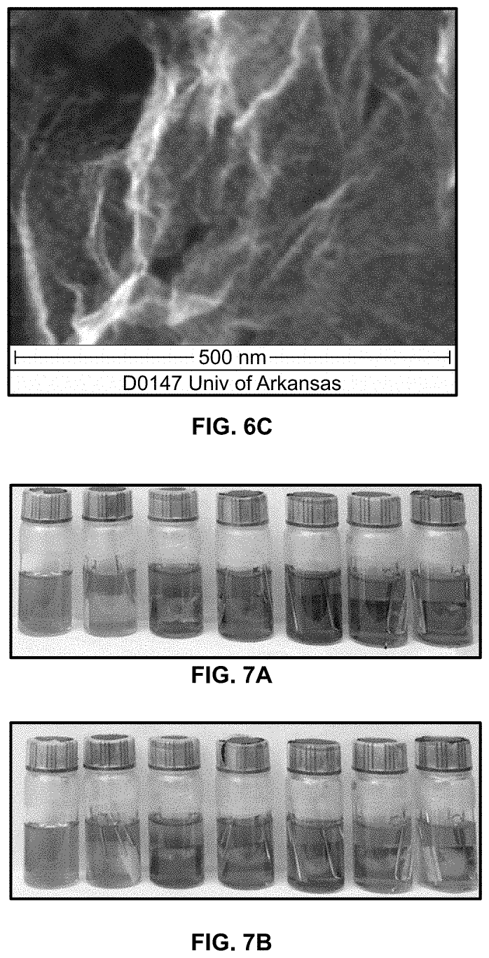

Electrode #4 was observed using scanning electron microscopy SEM), as illustrated in FIG. 5. It is easy to identify that S particles are in the nanoscale of ˜50 nm. The S nanoparticles locate on the surface of NG or they are covered by NG. In addition, The ALD-deposited ZnO and Al₂O₃ nanoparticles on NG were observed using SEM, as shown in FIG. 6. The ALD-deposited ZnO (FIG. 6(b)) and Al₂O₃(FIG. 6(c)) nanoparticles are very uniform after 5-cycle ALD deposition. Furthermore, the chemical adsorption capability of NG and ALD ZnO-coated NG was investigated, as shown in FIG. 7. 3 mg NG or ALD-coated NG powders were added to 5 mL Li₂S₆ of 15 mM. The ALD-coated and uncoated NG powders were wrapped into polymer separators in order to facilitate observation on the color change of the Li₂S₆ solutions. Judging from the color changes, evidently, the NG powder coated with 5-cycle ALD ZnO exhibited the best chemical adsorption ability to Li₂S₆ after 3 hours.

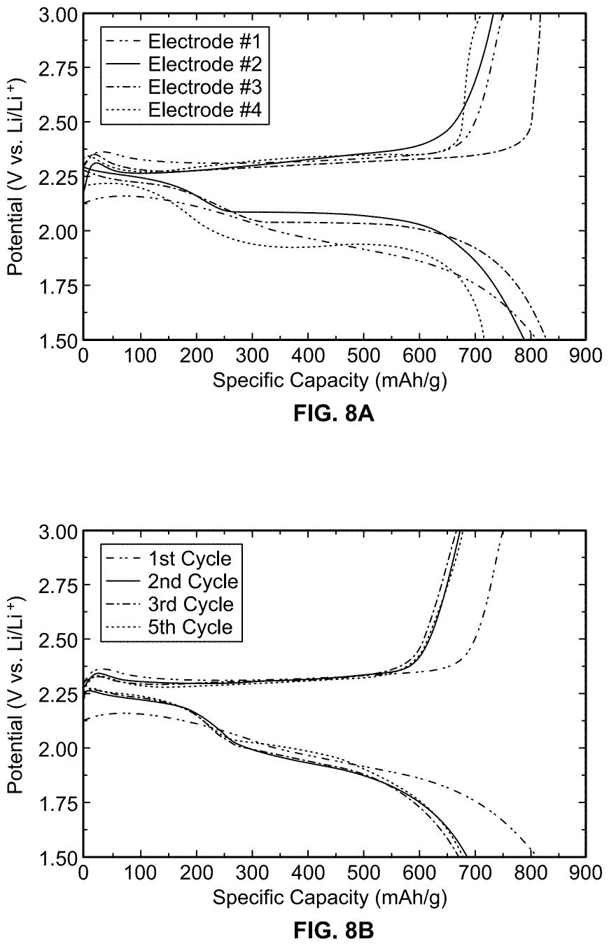

To gain a better understanding of the electrochemical behavior of the S cathodes, their capacities were examined versus their potentials during the electrochemical cycling. FIG. 8(a) shows the first discharge-charge cycle of the four cathodes tested at a current density of 500 mA/g. The first discharge profiles of the four cathodes can be divided into 4 distinct electrochemical regions. Region I results from the conversion of elemental sulfur into Li₂S₈, i.e., S₈+2Li→Li₂S₈. This stage shows a plateau at 2.2-2.3 V. Region II corresponds to the conversion of Li₂S₈ to low order polysulfides Li₂Sₙ (n≤6) and shows a decline in voltage to 2.1 V. Region III marks the conversion of dissolved low-order polysulfides into insoluble Li₂S₂ or Li₂S characterized by a lower voltage plateau at 1.9-2.1 V, and accounts for a majority of the Li—S battery capacity. Region IV results from the conversion of Li₂S₂ into Li₂S and is typically very short. The charge profile shows initially a sudden uptake followed by a long plateau at 2.2-2.4 V. The uptake is due to the phase transition from Li₂S to Li₂S₂, while the long plateau is the oxidization of Li₂S and Li₂S₂ into polysulfides and finally elemental S. In comparison, Electrode #1 has a lower discharge potential, probably due to its low electrical conductivity. In particular, it was noticed that Electrode #4 with ALD-Al₂O₃ nanoparticles showed a slope in Region III, different from the flat plateau with the Electrode #1, #2, and #3. This may be ascribed to the strong adsorption of ALD-Al₂O₃ nanoparticles to polysulfides. FIG. 8(b) illustrated the discharge-charge profiles of Electrode #4 in the first 5 cycles, showing very stable repeatability since the 2^{nd} cycle.

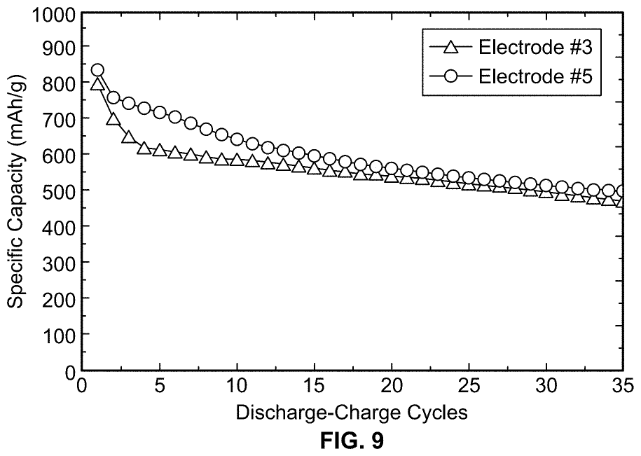

The effects of MLD coatings on S electrodes was examined by directly coating Electrode #3 with ZnGLP by MLD. As illustrated in FIG. 9, a 10-cycle MLD ZnGLP coating could help boost the discharge capacity of the coated electrode (i.e., Electrode #5). This may be due to a flexible polymeric barrier film formed on the Electrode #3, and the flexible outer coating inhibiting S shuttling.

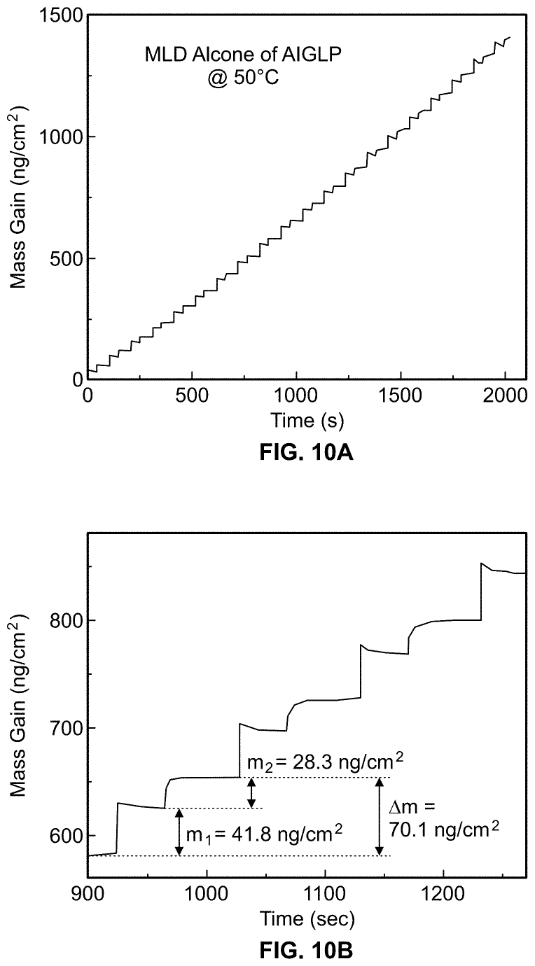

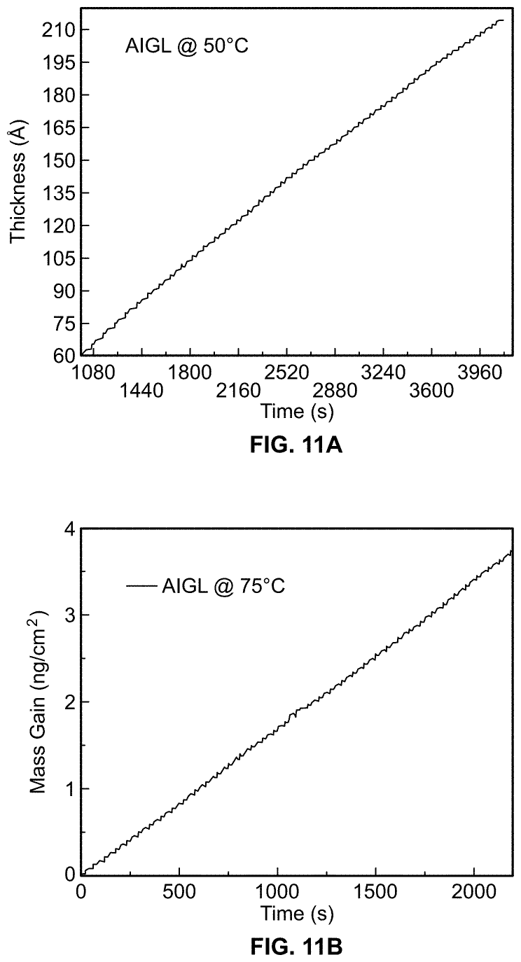

Two new MLD processes for alucones of AlGL and AlGLP were investigated, and two new MLD processes for zincones of ZnGL and ZnGLP were also investigated. In one embodiment, a MLD process for a new alucone using glycerol propoxylate (GLP) and trimethylaluminum (TMA) was used. Measurements of in situ QCM confirmed a linear growth in the range from 25° C. to 300° C. (see FIG. 10). Gglycerol (GL) and TMA were also used and these realized growth of AlGL alucone at low temperature from 25° C. to 100° C. (see FIG. 11). The surface chemistry of the MLD AlGLP can be described by two half-reactions, as follows:

|—OH+Al(CH₃)₃→|—O—Al(CH₃)₂+CH₄ (g) (1A)

O—Al(CH₃)₂+HO(C₃H₆O)ₙCH[CH₂(OC₃H₆)ₙOH]₂|—O—Al—[CH₂(OC₃H₆)ₙ]₂CH(C₃H₆O)ₙOH+2CH₄(g) (1B)

where “|” indicates the substrate surface, “n” represents an integral number, and “g” signifies gas phases.

Similarly, the surface chemistry of the MLD of AlGL is based on two half reactions, as follows:

|—OH+Al(CH₃)₃|O—Al(CH₃)₂+CH₄ (g) (2A)

—O—Al(CH₃)₂+HOCH(CH₂OH)₂|—O—Al—(CH₂)₂CHOH+2CH₄(g) (2B)

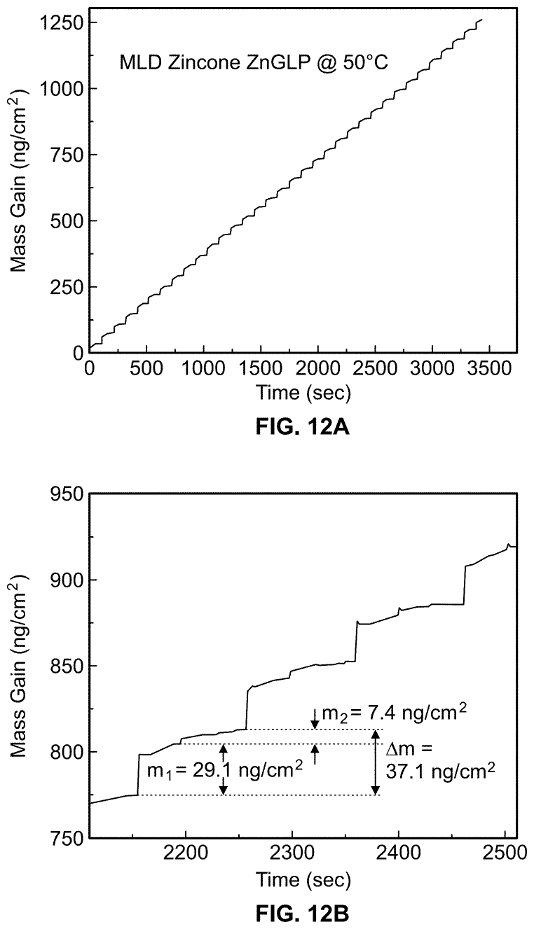

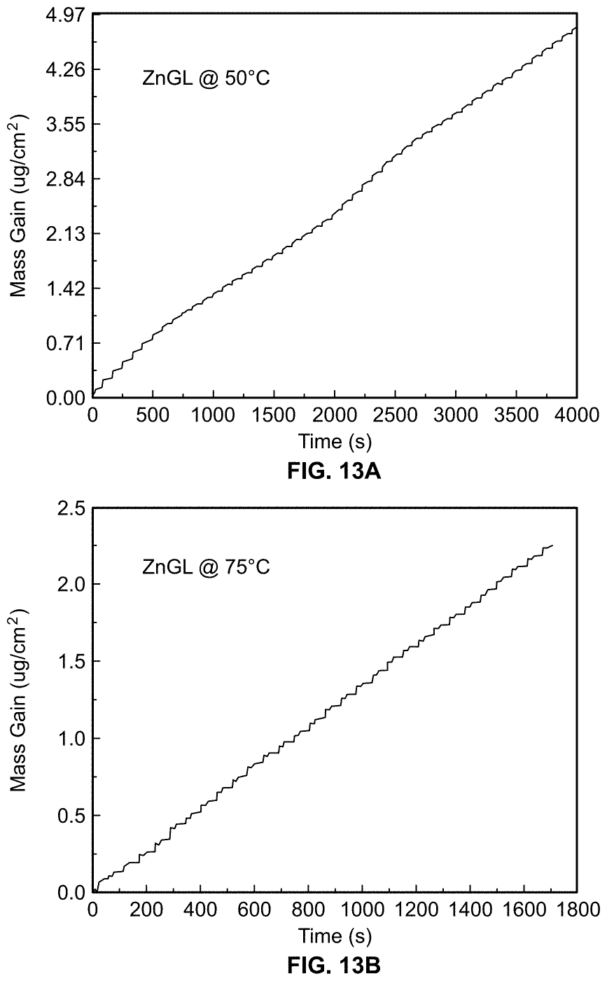

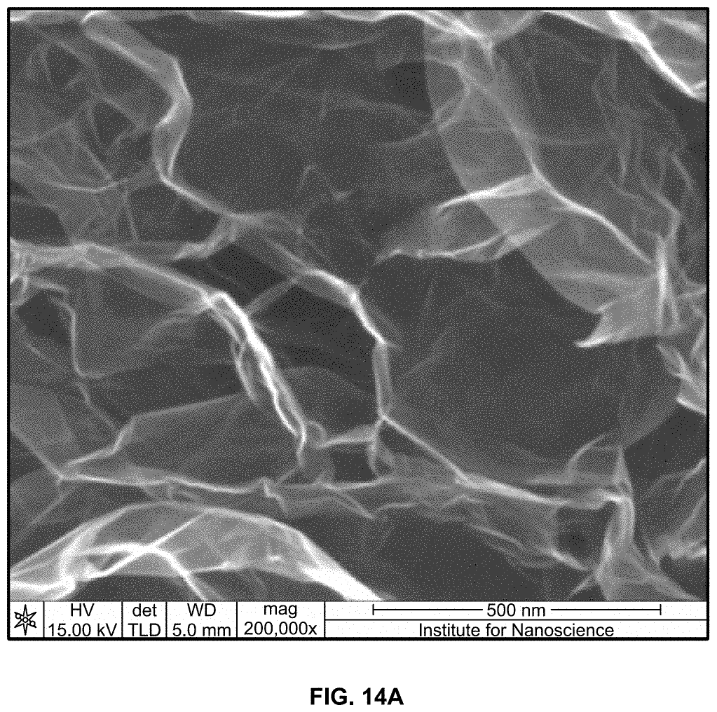

In addition, for other embodiments, a MLD process for a new zincone of ZnGLP using glycerol propoxylate (GLP) and diethylzinc (DEZ) was used. Measurements of in situ QCM confirmed a linear growth in the range from 25° C. to 300° C. (see FIG. 12). Glycerol (GL) and DEZ were also used to realize a growth of ZnGL zincone at low temperature from 25° C. to 100° C. (see FIG. 13).

The surface chemistry of the MLD ZnGLP can be suggested as follows:

|—OH+Zn(C₂H₅)₂→|—O—Zn(C₂H₅)+C₂H₆(g) (3A)

|—O—Zn(C₂H₅)+HO(C₃H₆O)ₙCH[CH₂(OC₃H₆)ₙOH]₂→|—O—Zn—O(C₃H₆O)ₙCH[CH₂(OC₃H₆)ₙOH]₂+C₂H₆(g) (3B)

The surface chemistry of the MLD ZnGL can be suggested as follows:

|—OH+Zn(C₂H₅)₂→|—O—Zn(C₂H₅)+C₂H₆ (g) (4A)

|—O—Zn(C₂H₅)+HOCH(CH₂OH)₂→|—O—Zn—OCH(CH₂OH]₂+C₂H₆(g) (4B)

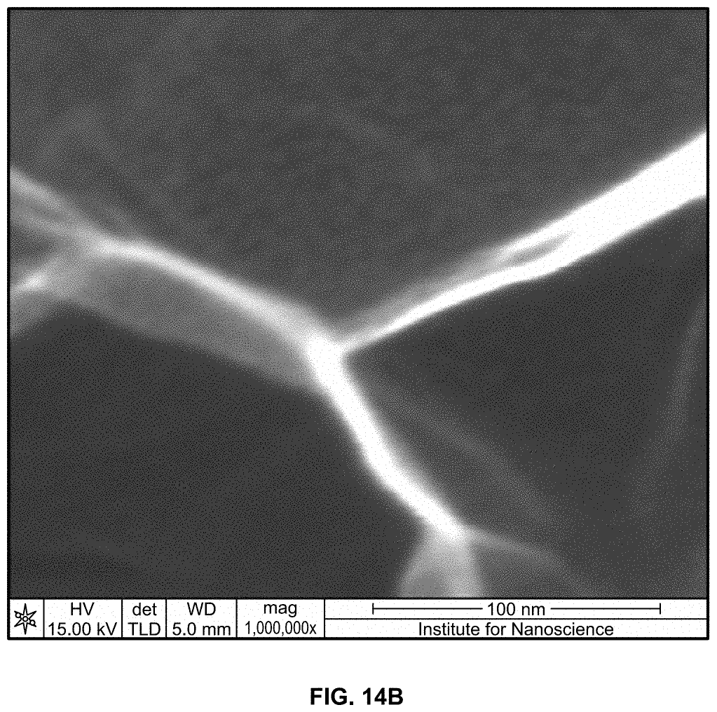

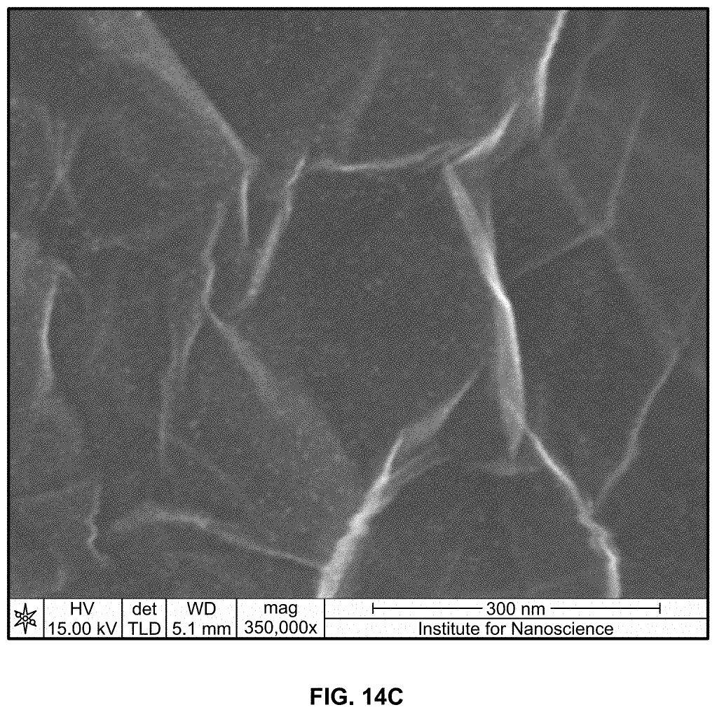

The deposition of the MLD processes was also examined using SEM. FIG. 14 shows that, in comparison to the bare NG (FIG. 14(a)), there was a uniform film formed after 20-cycle AlGLP (FIG. 14(b)) and 10-cycle ZnGL (FIG. 14(c)) at 50° C.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A method of inhibiting sulfur shuttle behaviors in lithium-sulfur batteries comprising the steps of combining S-adsorbent nanoparticles deposited by atomic layer deposition (ALD) or/and molecular layer deposition (MLD) and flexible polymeric films deposited by MLD.

2. The method of claim 2 wherein resultant Li—S cells have a specific cell energy density of >1500 Wh/kg.

3. The method of claim 1 wherein ALD is used for depositing inorganic adsorbents in nanoparticles and MLD is employed to grow a close flexible film outside the S cathode materials to create functional materials that inhibit the S shuttle behaviors in Li—S batteries.

4. The method of claim 1 wherein said ALD or/and MLD-deposited S-adsorbents serve as mediators of S active materials for improved electrical and ionic conductivity and for anchoring soluble polysulfides.

5. The method of claim 1 wherein said MLD-grown films are flexible polymeric films that act as a flexible network to boost the electrical conductivity of the S cathode.

6. The method of claim 1 wherein said S-adsorbents act as anchors of soluble polysulfides, which chemically prevent S species from shuttling between the S cathode and the lithium metal anode, and mediators of the S active materials for improved electrical and ionic conductivity.

7. The method of claim 1 wherein said S-adsorbents are nanoparticles of Al₂O₃ that act as anchors of soluble polysulfides, which chemically prevent S species from shuttling between the S cathode and the lithium metal anode, and mediators of the S active materials for improved electrical and ionic conductivity.

8. The method of claim 1 wherein MLD is employed to grow a close flexible film outside the S cathode materials, said flexible polymeric films function as (i) a reservoir of polysulfides, which block the direct contact between S active materials with a liquid electrolyte, physically retains excess polysulfides from escaping from the S cathode to accumulate 80% volume change of S active materials; and (ii) a flexible network to further boost the electrical conductivity of the S cathode.

9. The method of claim 8 wherein said flexible film is AlGL.

10. The method of claim 8 wherein said flexible film is AlGLP.

11. The method of claim 8 wherein said flexible film is ZnGL.

12. The method of claim 8 wherein said flexible film is ZnGLP.

13. A lithium-sulfur battery comprising:
S₈ particles coated by nanoparticles, said S₈ particles coated by nanoparticles covered by a polymeric film;
adsorbent-anchored polysulfides, said adsorbent-anchored polysulfides located in a resservior formed by a flexible film; and
cathode materials coated with nanoparticles, said cathode materials and said nanoparticles covered by a flexible film.

14. The battery of claim 13 wherein said flexible film is AlGL.

15. The battery of claim 13 wherein said flexible film is AlGLP.

16. The battery of claim 13 wherein said flexible film is ZnGL.

17. The battery of claim 13 wherein said flexible film is ZnGLP.

18. The battery of claim 13 wherein said S-adsorbents are nanoparticles of Al₂O₃

19. The battery of claim 13 wherein said S-adsorbents are inorganic nanoparticles.

20. The battery of claim 13 wherein said S-adsorbents are organic nanoparticles.
